(19) United States
(12) Patent Application Publication
(10) Pub. No.: US 2007/0270183 A1
(43) Pub. Date: Nov. 22, 2007

(54) Light emitting mobile communication device and charger therefor

(76) Inventor: Robin L. Tredwell, Stony Point, NY (US)

Correspondence Address: JAMES RAY & ASSOCIATES, 2640 PITCAIRN ROAD, MONROEVILLE, PA, 15146, US

(21) Appl. No.: 11/731,916

(22) Filed: Apr. 2, 2007

Related U.S. Application Data
(60) Provisional application No. 60/802,495, filed on May 22, 2006.

(51) Int. Cl. H04M 1/00

(52) U.S. Cl. 455/556.1

(57) ABSTRACT

The invention provides a novel light emitting mobile communication device. The device includes a light source, an independent power source, such as a battery and a switch which are integrated into the mobile communication device. According to another embodiment of the invention, the above elements are encased by a casing and a connector is disposed within the casing for attachment to the mobile communication device in a releaseable fashion. The invention also provides a novel charger for simultaneously recharging the mobile communication device battery and the independent flashlight battery.

### CROSS-REFERENCE TO RELATED APPLICATIONS

This application is related to and claims priority from Provisional Patent Application Ser. No. 60/802,495 filed May 22, 2006.

### FIELD OF THE INVENTION

The present invention relates, in general, to mobile communication devices and, more particularly, this invention relates to a light emitting mobile communication device enabling the user of such mobile communication device to securely and safely navigate in dark areas.

### BACKGROUND OF THE INVENTION

As is generally well known, many carry a mobile communication device with them at all times. Furthermore, many require the use of a flashlight to perform a task while talking on or using such mobile communication device. However, the user of such mobile communication device is disadvantaged by the fact that the flashlight may not be readily available as well as by the fact that the user generally does not have both hands available.

Prior to the present invention, efforts have been made to alleviate the aforementioned problems by combining flashlight functionality into such mobile communication device. U.S. Pat. No. 6,755,549 issued to Rogers et al, U.S. Pat. No. 6,611,697 issued to Ewing et al, U.S. Pat. No. 6,474,828 issued to Chin, U.S. Pat. No. 6,341,871 issued to Angelopoulos and U.S. Pat. No. 6,254,249 issued to Kim et al disclose various types of mobile handheld communication devices capable of emitting light.

One disadvantage of the prior art light emitting mobile communication devices is in their capability to view relatively small targets which are situated in close proximity to the device. For example, U.S. Pat. No. 6,755,549 discloses a useful distance of about one and four feet for the purpose of illuminating a map or other reading or writing surface or for the purpose of illuminating a knob or a lock to unlock a door. In U.S. Pat. No. 6,254,249, Kim et al shows a light emitting hand held communication device for reading a memorandum which is positioned in close proximity to such device. Therefore, the prior art device are not suitable in applications wherein a larger target must be illuminated at greater than presently available distances. For example, the user may need to illuminate a wide area covered by vegetation while jugging or walking or illuminate a portion of the home or vehicle from a greater distance for safety reasons.

Another disadvantage of the prior art light emitting mobile communication devices is in use of the device battery to power the light source. Since it is common to let the device battery to reach low levels of charging, problems arise in using such device for illuminating targets, particularly at greater than presently available distances or for prolong periods of time.

### SUMMARY OF THE INVENTION

According to one embodiment, the invention provides a mobile communication device including at least a housing, a battery mounted within the housing, and a display means viewable from a surface of the housing. In combination with the mobile communication device there is provided a flashlight which includes a light means capable of generating a light beam and emitting the light beam along a light beam path and in a direction away from the housing. The light beam has each of a predetermined intensity and a predetermined brightness. An independent power source is also provided and is capable of supplying a predetermined voltage to the light means. The supply of the predetermined voltage to the light means enables it to emit the light beam. A control means is used for selectively activating and terminating the supply of the predetermined voltage from the independent power source to the light means.

According to another embodiment of the invention, therein is provided a flashlight for attachment to a mobile communication device. The flashlight includes a housing and a light means which is disposed within the housing and which is operable upon supply of predetermined voltage to generate a light beam and emit the light beam along a light beam path and in a direction away from the housing. The light beam has each of a predetermined intensity and a predetermined brightness. A power source is mounted within the housing and is capable of supplying a predetermined voltage to the light means, whereby the supply of the predetermined voltage to the light means enables it to emit the light beam. A control means is electrically connected intermediate the light means and the power source for selectively activating and terminating the supply of the predetermined voltage from the power source to the light means. A first connector is mounted within the housing and has a portion thereof capable of connecting to a connector disposed within the mobile communication device.

According to yet another embodiment, the invention provides a charging device which includes a housing and means secured to the housing for connecting the charging device to a source of supply voltage. A first charging circuit is disposed within the housing. The first charging circuit is in electrical communication with the connection means for generating a first output voltage. A second charging circuit is also disposed within the housing. The second charging circuit is in electrical communication with the connection means for generating a second output voltage. An output connector is in electrical communication with each of the first and second charging circuit means for delivering the first output voltage to a first battery and for delivering the second output voltage to a second battery.

### OBJECTS OF THE INVENTION

It is, therefore, one of the primary objects of the present invention to provide a mobile communication device which is capable of emitting light.

Another object of the present invention is to provide a light emitting mobile communication device which enables the user to view targets at greater than presently available distances.

Yet another object of the present invention is to provide a light emitting mobile communication device which employs a separate battery to operate the light source.

A further object of the present invention is to provide a light emitting mobile communication device which enables the device battery and the separate light source battery to be charged from the same charging device.

Yet a further object of the present invention is to provide a light emitting mobile communication device which is economical to manufacture.

An additional object of the present invention is to provide a light emitting mobile communication device which allows for the light emitting portion to be removably attached to the battery jack of the mobile communication device portion.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a front planar view of the light emitting mobile communication device of the present invention;

FIG. 2 is a rear planar view of the light emitting mobile communication device of FIG. 1; and

FIG. 3 is a block diagram of the light emitting mobile communication device of FIG. 1;

FIG. 4 is a planar view of the flashlight connectable to a connector of a mobile communication device;

FIG. 5 is a planar view of the battery charger usable with the mobile communication device of FIG. 1 and constructed according to one embodiment of the invention;

FIG. 6 is a planar view of the battery charger usable with the mobile communication device of FIG. 1 and constructed according to another embodiment of the invention; and

FIG. 7 is a schematic diagram of the battery charger of FIGS. 5 or 6.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

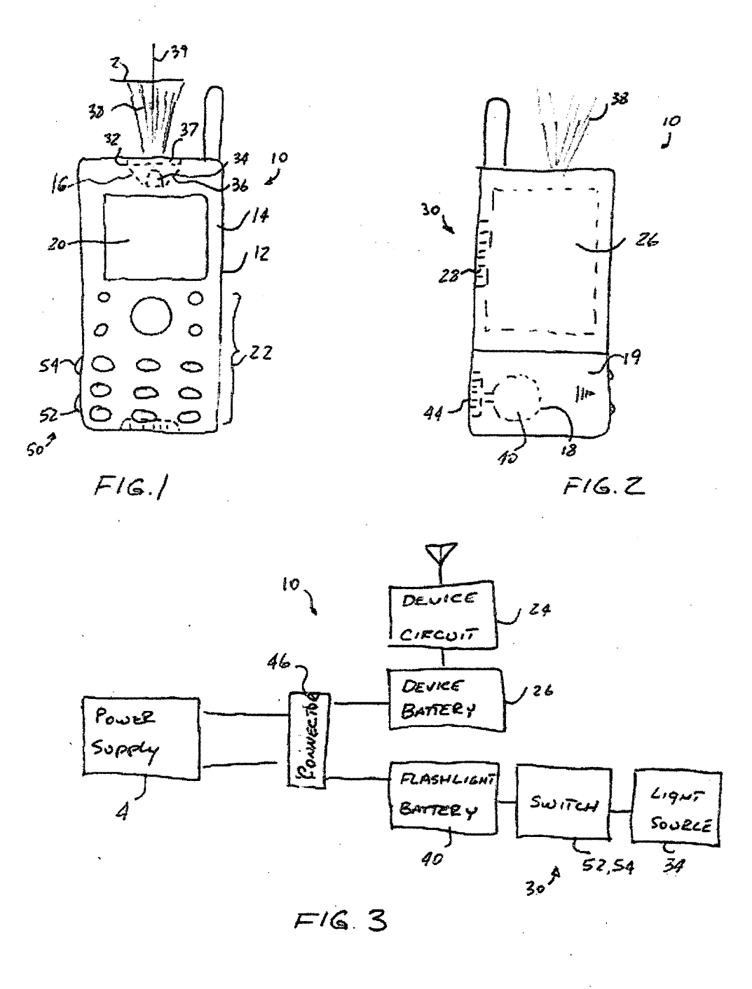

Reference is now made, to FIGS. 1-3, wherein there is shown a mobile communication device, generally designated as 10. By way of example only, the mobile communication device 10 is shown as a well known mobile phone which includes at least a housing 12, a display means 20 viewable from a front surface 14 of the housing 12, a keypad means 22 operable from the front surface 14, and a circuit means 24 and a battery 26 which are mounted within the housing 12.

The present invention provides a novel flashlight, generally designated as 30, which is usable in combination with the mobile communication device 10.

According to one embodiment of the invention, such flashlight 30 is integrated into the mobile communication device 10. Specifically, the flashlight 30 includes a light means 32 which is capable of generating and a light beam 38 and emitting the light beam 38 along a light beam path 39 and in a direction away from the housing 12. The light beam 38 has each of a predetermined intensity and a predetermined brightness. The light means 32 includes a light source 34 and a reflector means 36 which are mounted in a well known relationship within a first cavity 16 formed in a predetermined portion of the housing 12. If required, a lens 37 may be also disposed on and secured to the housing 12. The lens 37 is typically made from a transparent material that allows the light beam 38 to pass through but may be provided in a variety of colors depending on user preference.

The light source 34 may be selected from a group consisting of well known super-bright light emitting diode, ultra-bright light emitting diode, light bulb and various combinations thereof. As it is well known, the light source 34 may be provided in a variety of colors depending on user preference.

An independent power source is provided for supplying a predetermined voltage to the light means 30, whereby the supply of the predetermined voltage to the light means 30 enables it to emit the light beam 38. Such independent power source is a battery 40 and moreover a rechargeable battery 40 of a lithium-ion type, which is positioned within a second cavity 18 formed in the housing 12 and accessible through the cover 19. The presently preferred rechargeable battery 40 is capable of delivering about 3.0 VDC to the light means 30.

Accordingly, the mobile communication device 10 further includes a connector means 44 disposed within the housing 12 and electrically coupled to the battery 40.

Such connector means 44 may be independent from the connector means 28 which is disposed within the housing 12 for recharging the battery 26 of the mobile communication device 10. However, the present invention contemplates that the mobile communication device 10 will be adapted with a single connector means 46 capable of simultaneously recharging both batteries 26 and 40.

A control means, generally designated as 50, is provided for selectively activating and terminating the supply of the predetermined voltage from the power source to the light means 30. Preferably, such control means is a well known switch means 52 which is positioned within a side wall 15 of the housing 12 and which is electrically connected intermediate the light means 30 and the battery 40. The switch means 52 is manually operable to activate the supply of predetermined voltage and than is manually operable to terminate such supply of predetermined voltage. The present invention contemplates that the switch means 52 is manually operable to activate the supply of predetermined voltage and that the circuit means 24 of the mobile communication device 10 is adapted to terminate such supply of predetermined voltage. Alternatively, the switch means 52 may be manually operable to activate the supply of predetermined voltage and a second witch means 54 will be provided to terminate such supply of predetermined voltage. Furthermore, the control means 50 may be simply achieved by using a keypad means 22. Such embodiment is taught in U.S. Pat. No. 6,755,549 issued to Rogers et al, whose teaching is incorporated into this document by reference thereto.

In operation, the user simply operates the switch means 52 to selectively emit the light beam 38.

The combination of the light source 34, the reflector means 36 and the battery 40 of the present invention is sufficient to emit the light beam 38 capable of illuminating a target 2 at a distance of greater than four feet from the mobile communication device 10. It has been determined that use of a 3V button or coin type battery enables the light beam 38 to adequately illuminate an object at a distance of between about 12 feet and about 15 feet from the position of the mobile communication device 10. It has been further determined that use of a single 6V battery or a pair of 3V batteries connected in series with each other enables the light beam 38 to adequately illuminate an object at a distance of greater than 25 feet from the position of the mobile communication device 10. It will be understood that the aforementioned distances enable the user of the mobile communication device 10 to illuminate a wide area covered by vegetation (not shown) while jugging or walking or to illuminate a portion of the home (not shown) or vehicle (not shown) for safety reasons.

The independent power source, such as battery 40, is advantageous in emitting the light beam 38 in situations when the battery 26 of the mobile communication device 10 reached low levels of charging which is a common phenomenon for many users. Accordingly, the user can illuminate the target 2 for prolong periods of time even when the use of the mobile communication device 10 is disabled due to such low charging levels. Thus, the user does not comprise his or her safety.

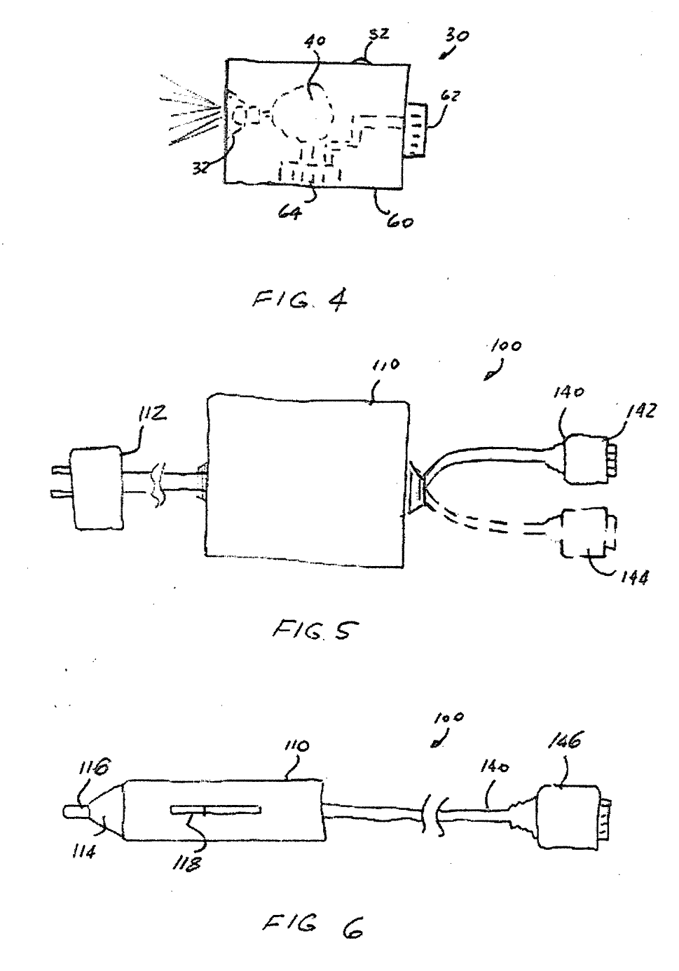

According to another embodiment, best shown in FIG. 4, the present invention provides a flashlight 30 which is releaseably connected to the mobile communication device 10. In this embodiment, the light means 32, the battery 40 and the switch means 52 is mounted within a casing 60 having a predetermined shape and size. The flashlight 30 further include a first connector means 62 which is capable or operatively coupling to the connector means 28 of the mobile communication device 10. When such connector means 28 is a well known socket, the first connector means 62 is a complimentary plug. Accordingly, the flashlight 30 is simply connected to the mobile communication device 10 in a releaseable semi-permanent manner for use as a unitary arrangement. Since typically most users carry the mobile communication device 10 with them at all times, presence of the flashlight 30 is easily afforded when required. Preferably, the casing 60 is dimensioned complimentary to the mating dimensions of the housing 12 and is shaped in a manner to provide a simple extension of the mobile communication device 10 for convenience of use.

In order to enable the user to recharge the power source 40, the flashlight 30 of this embodiment includes a second connector means 64 which is disposed within the casing 60 in electrical communication with the first connector means 62. Thus, the charging device (not shown) connected to such flashlight 30 is capable of simultaneously recharging both batteries 26 and 40.

Now in reference to FIGS. 5-7, therein is illustrated a novel charging device, generally designated as 100. Such charging device includes a housing 110 and a means secured to the housing 110 for connecting the device 100 to a source of supply voltage 102. In further reference to FIG. 5, such connecting means is a well known electrical plug 116 for connecting the charging device 100 to a source of AC voltage (not shown).

FIG. 6 illustrates another embodiment of the charging device 100 having a housing 110 wherein a first end 114 is adapted to be received into a cigarette light receptacle of a vehicle (not shown) in a slip fit engagement. The first end 114 of the housing 110 also includes a positive electrical contact 116 for communication with the complimentary positive contact of the cigarette lighter receptacle (not shown) and the housing 110 has negative electrical contacts 118 disposed thereon for engaging the complimentary negative electrical contacts of the cigarette lighter receptacle (not shown).

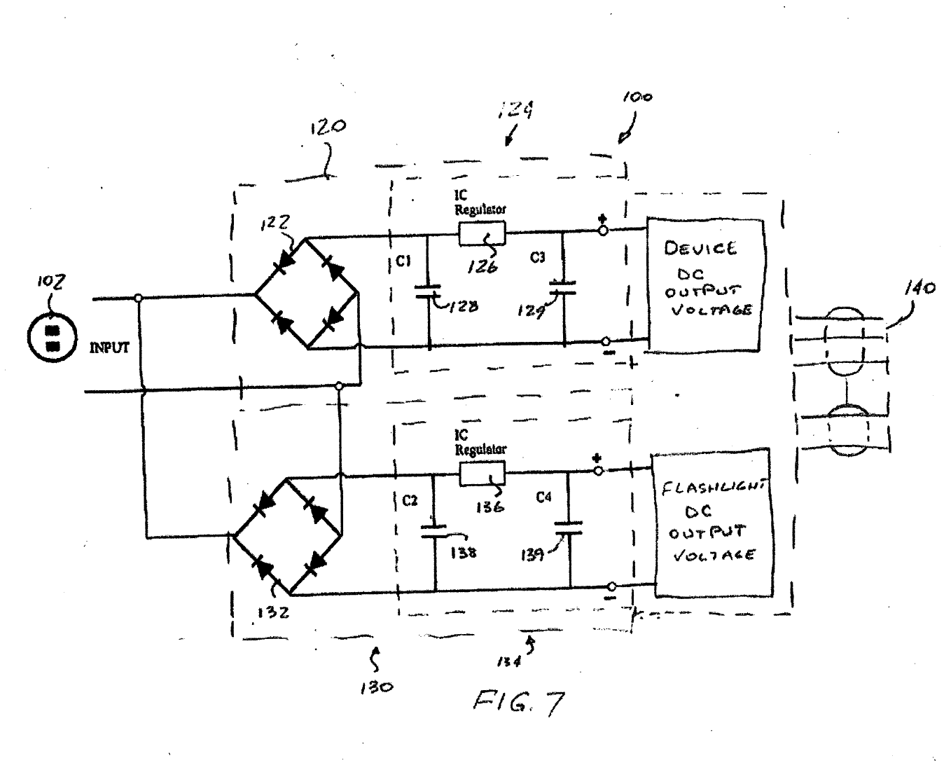

Now in reference to FIG. 7, a first charging circuit means 120 is disposed within the housing 110 in electrical communication with the supply voltage connection means for generating a first output voltage.

A second charging circuit means 130 is disposed within the housing 110 in electrical communication with the supply voltage connection means for generating a second output voltage.

It will be understood that that employment of first and second charging circuit means, 120 and 130 respectively, is advantageous for use in applications wherein the battery 26 of the mobile communication device has different voltage rating that the voltage rating of the battery 40 of the flashlight 30.

An output connector means 140 is provided in electrical communication with each of the first and second charging circuit means 120 and 130, respectively, for delivering the first output voltage to a first battery, such as battery 26 of the mobile communication device 10 and for providing the second output voltage to a second battery, such as battery 40 of the flashlight 30. Such output connector means 140 may be a pair of output connectors 142 and 144, best shown in FIG. 5, which may be advantageous in simultaneously and independently recharging the mobile communication device 10 and the disconnected flashlight 30. Or, the output connector means 140 may be a single connector 146, best shown in FIG. 6, which is advantageous for recharging the combination of the mobile communication device 10 and the flashlight 30 of FIG. 1. Although, a single connector 146 is shown in combination with the charging device 100 of FIG. 6, it will be apparent to those skilled in the art that a pair of connectors 142 and 144 of FIG. 5 may be used with the charging device 100 of FIG. 6. Accordingly, a single connector 146 may be employed with the charging device 100 of FIG. 5.

The first charging circuit means 120 includes a bridge rectifier means 122 in electrical communication with the supply voltage connecting means and a voltage regulating and conditioning means, generally designated as 124, in electrical communication with the bridge rectifier 122 and the output connector means 140. The voltage regulating and conditioning means 124 may simply include an IC regulator 126 and a pair of capacitors 128 and 129.

Accordingly, the second charging circuit means 130 includes a bridge rectifier means 132 in electrical communication with the supply voltage connecting means 110 and a voltage regulating and conditioning means, generally designated as 134, in electrical communication with the bridge rectifier 132 and the output connector means 140. The voltage regulating and conditioning means 134 may simply include an IC regulator 136 and a pair of capacitors 138 and 139.

Although the present invention has been shown in terms of the well known mobile phone, it will be apparent to those skilled in the art, that the present invention may be applied to other mobile communication devices, such as personal digital assistant (PDA), pager, mobile computing device (MCD), radio, portable computer and the like.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. In combination with a mobile communication device including at least a housing, a battery mounted within the housing, and a display means viewable from a surface of the housing, a flashlight comprising:
(a) a light means for generating a light beam and for emitting said light beam along a light beam path and in a direction away from said housing, said light beam having each of a predetermined intensity and a predetermined brightness;
(b) an independent power source which is capable of supplying a predetermined voltage to said light means, whereby said supply of said predetermined voltage to said light means enables it to emit said light beam; and
(c) a control means for selectively activating and terminating said supply of said predetermined voltage from said independent power source to said light means.

2. The combination, according to claim 1, wherein said light means includes a light source which is positioned within a cavity formed in a predetermined portion of said housing.

3. The combination, according to claim 2, wherein said light source includes one of a super-bright light emitting diode, ultra-bright light emitting diode, light bulb and various combinations thereof.

4. The combination, according to claim 1, wherein said light beam is sufficient to illuminate a target at a distance of greater than four feet.

5. The combination, according to claim 1, wherein said independent power source is positioned within a power source cavity formed in said housing.

6. The combination, according to claim 1, wherein said independent power source is a battery.

7. The combination, according to claim 6, wherein said battery is a rechargeable battery.

8. The combination, according to claim 7, wherein said mobile communication device further includes a connector means disposed within said housing and wherein said rechargeable battery is electrically coupled to said connector means.

9. The combination, according to claim 1, wherein said control means includes a switch means electrically connected intermediate said light means and said independent power source.

10. The combination, according to claim 9, wherein said switch means is positioned within a side wall of said housing.

11. The combination, according to claim 1, wherein said flashlight includes a casing which encases said light means, said independent power source and said switch means, a first connector means which has a portion thereof extending from said casing for operably engaging a connector means of said mobile communication device, and a second connector means mounted within said casing for coupling to a charging means, wherein said second connector means is in electrical communication with said first connector means and wherein a combination of said second connector means and said first connector means is capable of charging said independent power source of said flashlight and said battery of said mobile communication device.

12. A flashlight for attachment to a mobile communication device, said flashlight comprising:
(a) a housing,
(b) a light means disposed within said housing and operable upon supply of a predetermined voltage to generate a light beam and emit said light beam along a light beam path and in a direction away from said housing, said light beam having each of a predetermined intensity and a predetermined brightness,
(c) a power source mounted within said housing and capable of supplying said predetermined voltage to said light means, whereby said supply of said predetermined voltage to said light means enables it to emit said light beam;
(d) a control means electrically connected intermediate said light means and said power source for selectively activating and terminating said supply of said predetermined voltage from said power source to said light means; and
(e) a first connector means mounted within said housing and having a portion thereof for connecting to a connector means disposed within the mobile communication device.

13. The flashlight, according to claim 11, wherein said power source is a battery and wherein said flashlight includes a second connector means disposed within said housing for connecting said flashlight to a charging means, said second connector means in electrical communication with said first connector means, wherein said charging means is capable of simultaneously charging said flashlight battery and a battery disposed within the mobile communication device.

14. A charging device comprising:
(a) a housing;
(b) a connecting means secured to said housing for connecting said device to a source of supply voltage;
(c) a first charging circuit means disposed within said housing in electrical communication with said connection means for generating a first output voltage;
(d) a second charging circuit means disposed within said housing in electrical communication with said connection means for generating a second output voltage; and
(e) an output connector means in electrical communication with each of said first and second charging circuit means for delivering said first output voltage to a first battery and for delivering said second output voltage to a second battery.

15. The charging device, according to claim 14, wherein said first charging circuit means includes a bridge rectifier circuit in electrical communication with said supply voltage connecting means and a voltage regulating and conditioning circuit in electrical communication with said bridge rectifier and said output connector means.

16. The charging device, according to claim 15, wherein said voltage regulating and conditioning circuit includes a regulating device and a pair of capacitors.

17. The charging device, according to claim 14, wherein said output connector means includes a first connector plug for delivering said first output voltage and a second connector plug for delivering said second output voltage.

18. The charging device, according to claim 14, wherein said connecting means includes an end of said housing which is adapted to be received into a cigarette light receptacle of a vehicle in a slip fit engagement, a positive electrical contact disposed on said end for communication with a complimentary positive contact of the cigarette lighter receptacle and negative electrical contacts disposed on said housing for engaging complimentary negative electrical contacts of the cigarette lighter receptacle.
